(19) United States
(12) Patent Application Publication
(10) Pub. No.: US 2012/0155990 A1
(43) Pub. Date: Jun. 21, 2012

(54) SCREW STRUCTURE

(76) Inventor: Chien-Chin CHAO, Changhua County (TW)

(21) Appl. No.: 12/969,311

(22) Filed: Dec. 15, 2010

(51) Int. Cl. F16B 35/04

(52) U.S. Cl. 411/412

(57) ABSTRACT

An improved screw includes a head and a shank. The head has a wrench cavity on the top to be driven by a screwdriver. The shank is connected to the bottom of the head. The shank has a round shank at an upper end close to the head to form a left-hand thread section, and a triangular shank at a lower end to form a right-hand thread section. The left-hand and right-hand thread sections have thread points formed in an asymmetrical manner. The right-hand thread section further has an upper thread section and a lower thread section at the bottom to form the tip. The lower thread section has saw-toothed threads. Thus tapping efficiency improves when the screw is fastened to a workpiece, and faster and firmer fastening can be achieved.

### FIELD OF THE INVENTION

The present invention relates to a screw structure and particularly to an improved screw that has a triangular shank with right-hand threads and a round shank with left-hand threads to enhance construction efficiency and achieve firmer fastening.

### BACKGROUND OF THE INVENTION

Screws are widely used for coupling non-metal workpieces such as plastics and woods. A screw generally has a tip at the front end to pierce a workpiece, then is screwed forwards through threads which cut and squeeze the material of the workpiece to form corresponding threads to attain secure fastening.

However, when the screw is screwed into the workpiece, the tip would encounter resistance of the material during cutting and squeezing. Since the shank of the screw is usually formed in a round section and the threads are in contact with the workpiece in line or surface during screwing, greater friction force is generated and difficulty of screwing forward is increased. Users have to exert more efforts and time to fasten the screw to the workpiece, and construction efficiency suffers. There is still room for improvement.

### SUMMARY OF THE INVENTION

The primary object of the present invention is to overcome the aforesaid disadvantages of the conventional screws by providing an improved screw with a novel shank and right-hand and left-hand thread sections to enhance screw drilling effect based on mechanics to achieve faster and firmer fastening with less effort.

To achieve the foregoing object, the screw structure according to the invention includes a head and a shank. The head has a wrench cavity on the top to be driven by a screwdriver. The shank is connected to the bottom of the head and has a tip at the bottom end, and a round shank at an upper end close to the head and a triangular shank at a lower end. The round shank has a left-hand thread section annularly formed thereon. The triangular shank has a right-hand thread section annularly formed thereon. The left-hand and right-hand thread sections have thread points formed in an asymmetrical manner. The right-hand thread section further has an upper thread section and a lower thread section. The lower thread section has saw-toothed threads.

By means of the structure set forth above, the invention provides many benefits, notably:

1. With the triangular shank at the lower end and the round shank at the upper end of the screw, when the triangular shank is screwed into a workpiece, the contact area with the workpiece is reduced, and resistance encountered during tapping is smaller, thus construction can be done faster with less effort.

2. With the right-hand thread section at the lower end and left-hand thread section at the upper end of the shank mating with each other, the screw is firmly fastened to the workpiece due to being squeezed by the material of the workpiece.

3. With the saw-toothed threads formed on the lower thread section of the triangular shank, fibers of the workpiece can be damaged faster during screwing to improve construction efficiency.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a front view of the screw of the invention.

FIG. 2 is a sectional view taken on line 2B-2B in FIG. 1.

FIG. 3 is a sectional view taken on line 3B-3B in FIG. 1.

FIG. 4 is a fragmentary enlarged view of the saw-toothed threads of the lower thread section according to FIG. 1.

### DETAILED DESCRIPTION OF THE PREFERRED EMBODIMENT

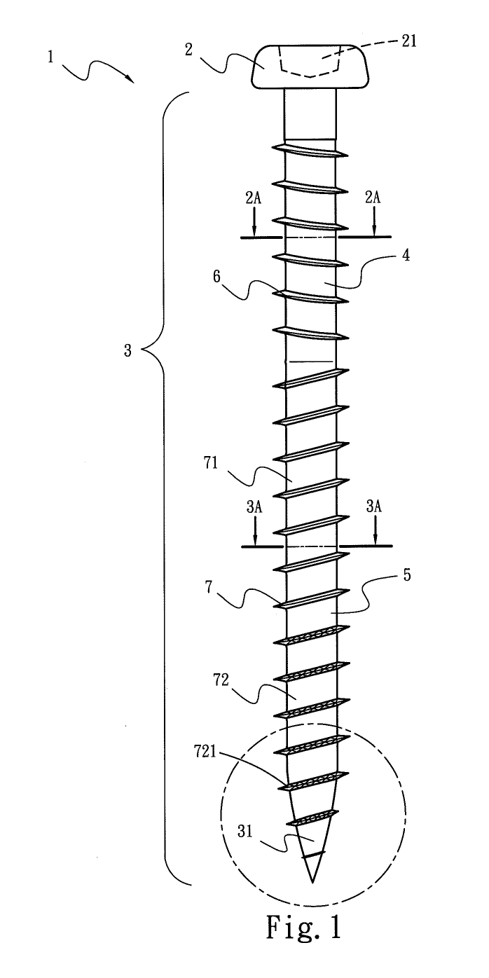

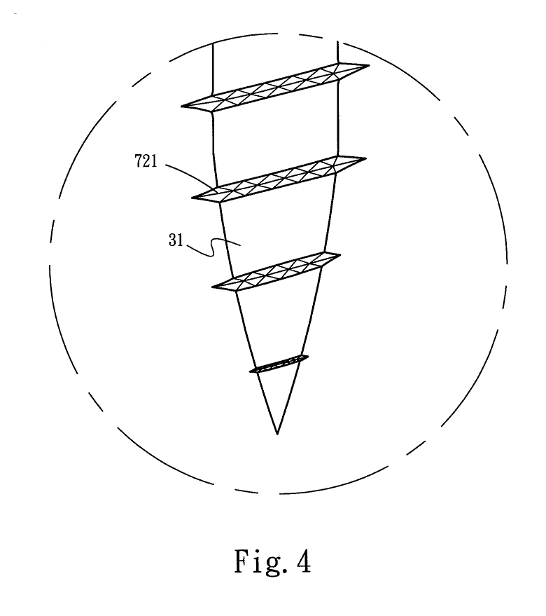

Please refer to FIGS. 1 through 4, the present invention provides an improved screw 1 which includes a head 2 and a shank 3 connected to the bottom of the head 2.

The head 2 has a wrench cavity 21 on the top to be driven by a screwdriver.

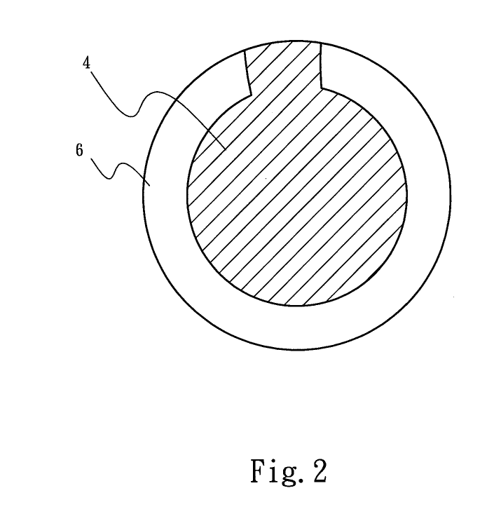

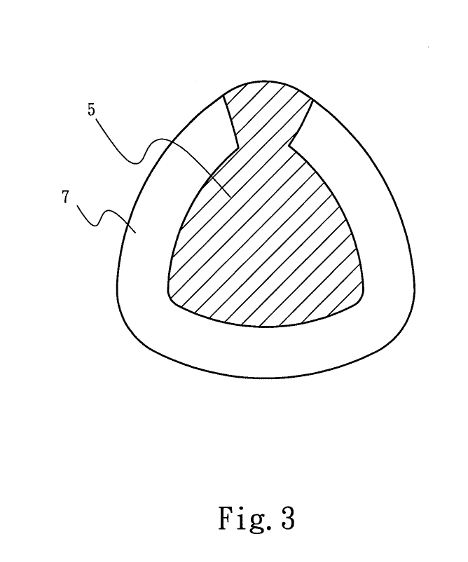

The shank 3 has a tip 31 at the bottom end and a round shank 4 at an upper end close to the head 2 and a triangular shank 5 for the remained portion of the shank 3 at a lower end. The round shank 4 has a left-hand thread section 6 formed annularly thereon in a circular profile (referring to FIG. 2). The triangular shank 5 has a right-hand thread section 7 formed annularly thereon in a triangular profile (referring to FIG. 3). The left-hand and right-hand thread sections 6 and 7 have thread points formed in an asymmetrical manner with unequal inclined angles. However, this is a technique known in the art, thus details are omitted herein. The right-hand thread section 7 further has an upper thread section 71 and a lower thread section 72. The lower thread section 72 has saw-toothed threads 721.

By means of the aforesaid structure, when the screw 1 is in use, the tip 31 pierces a workpiece; the wrench cavity 21 of the head 2 is engaged with a screwdriver and wrenched, and the lower thread section 72 of the right-hand thread section 7 starts tapping. As the saw-toothed threads 721 formed on the lower thread section 72, greater cutting effect during screwing is enhanced. Moreover, with the triangular shank 5 formed on the lower end of the shank 3, the right-hand thread section 7 with the triangular profile forms point contact with the workpiece, hence friction force generated during screwing is reduced. After the upper thread section 71 has been screwed into the workpiece, the left-hand thread section 6 with the circular profile annularly formed on the upper end of the round shank 4 allows the screw 1 to form a line or surface contact with the workpiece. Thus through the corresponding right-hand thread section 7 and left-hand thread section 6, the screw 1 is firmly fastened to the workpiece during screwing due to being squeezed by the workpiece to form secure fastening effect.

What is claimed is:

1. A screw comprising a head and a shank connected to the bottom of the head, the head including a wrench cavity on the top to be driven by a screwdriver, the shank including a tip at the bottom end, wherein:
the shank includes a round shank with a selected length at an upper end close to the head and a triangular shank for the remained portion thereof at a lower end, the round shank including a left-hand thread section formed annularly thereon in a circular profile, the triangular shank including a right-hand thread section formed annularly thereon in a triangular profile, the left-hand and right-hand thread sections including thread points formed in an asymmetrical manner, the right-hand thread section further including an upper thread section and a lower thread section, the lower thread section including saw-toothed threads.
